(19) United States
(12) Patent Application Publication
(10) Pub. No.: US 2007/0240701 A9
(43) Pub. Date: Oct. 18, 2007

(54) Oven

(75) Inventors: Wolfgang Schnell, Trostberg (DE); Klaus Rabenstein, Trostberg (DE); Klemens Roch, Trostberg (DE); Michael Wagner, Grabenstatt (DE); Rainer Lebacher, Palling/Freutsmoos (DE); Christine Thaller, Tengling (DE); Robert Hasslberger, Ruhpolding (DE); Hans Lappat, Garching/Alz (DE); Peter Lohner, Altenmarkt (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 10/445,704

(22) Filed: May 27, 2003

Related U.S. Application Data
(63) Continuation of application No. PCT/EP01/13281, filed on Nov. 16, 2001.

(30) Foreign Application Priority Data
Nov. 29, 2000 (DE) 10059167.1

(51) Int. Cl. A21B 1/00

(52) U.S. Cl. 126/273 R; 126/190

(57) ABSTRACT

The invention relates to an oven comprising a sealing element (2) that, for sealing an oven door, rests only against a cool area (14) of an oven flange (4) without contacting the hot area (12) of the oven flange. Both areas (12, 14) are thermally isolated (10) from one another

The invention relates to an oven, in particular those with pyrolysis mode for self-cleaning, in accordance with the preamble of claim 1.

Accordingly, the invention relates to an oven containing an oven flange, which extends like a frame around the supply opening of an oven space and has a thermal decoupling area, which heat-wise separates a “hot area” adjacent to the supply opening and a “cold area” further away from the supply opening relative thereto, and also relates to a sealing element affixed to the oven flange and lying against the latter as a seal, and on which an oven door rests when the door is open to seal the oven space from the oven space exterior.

An oven of this type is known from German utility model G 91 06 860.6. To attach a seal made of a high-temperature-resistant material, e.g. fibre glass material, on the oven or its door plug-in clamps are provided which on the one hand are hooked on a wire cable, extending axially through the seal, and on the other hand can be snapped into openings on the oven or on the door. The seal lies in a bead, in whose bead base the openings are formed.

DE 197 05 697 A1 discloses an oven in which a cavity, forming a heat decoupling gap between both these components, is formed between the muffle walling of the oven space and a front frame of the muffle wall. The cavity is sealed by a seal made of a heat-insulating material, which lies on the front frame and on the muffle walling and exhibits a sealing element, wing-like in cross-section, on which the oven door can lie tightly. The seal comprises a high-temperature-resistant material, so that it is not damaged by the high temperatures originating in the oven space.

The temperatures for cooking, roasting, grilling and the like originating in the oven space normally do not rise above 280° C. In pyrolysis mode for automatic cleaning of the oven space, during which dirt residue is burnt off by high temperatures, the pyrolysis temperature can be over 400° C. Currently known sealing material, which withstands these temperatures, is for example a fibre glass braided strand. This is not only expensive, but also has the disadvantages of having a poor sealing effect, being extracted with fat and damping parts of the oven space, also hardening, looking unsightly and not being sufficiently clean. This is in contrast to seals, for example comprising silicon, which however are not as resistant to high temperatures, but withstand for example only those temperatures up to a maximum of around 280° C.

To save power in modern ovens the oven flange is separated thermally by a gap, via a plurality of protectors or other openings, and/or by grooves or beads from the oven pipe (oven muffle). So that on the one hand these thermal separation means are not visible to the customer, and on the other hand the oven pipe is sealed, they lie behind the door seal, in special embodiments on the base of a groove or bead extending around the supply opening, which itself also acts as thermal decoupling means. A strong temperature spike occurs at the separation point determined by the thermal separation. On the oven side the temperatures, in particular in pyrolysis mode, are very high, for example higher than 310° C. For a silicon seal lying on this surface this temperature is too high, such that according to the prior art only a fibre glass material seal can be used.

The invention is to solve the task of designing the sealing arrangement between the oven space and the oven door such that it is less capable of picking up dirt and can be kept clean more easily, and has a good sealing effect for sealing the oven space air against the oven space exterior and has an acceptable appearance.

This task is solved according to the present invention by the characteristics of claim 1.

According to the present invention in a pyrolysis device for the first time a silicon seal can be used, because the seal does not contact the hot area of the oven flange.

Further characteristics of the invention are incorporated in the sub-claims.

The invention will now be described hereinbelow with respect to the diagrams by means of preferred embodiment as examples, in which

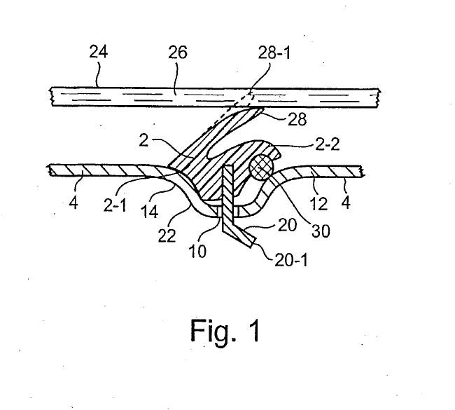

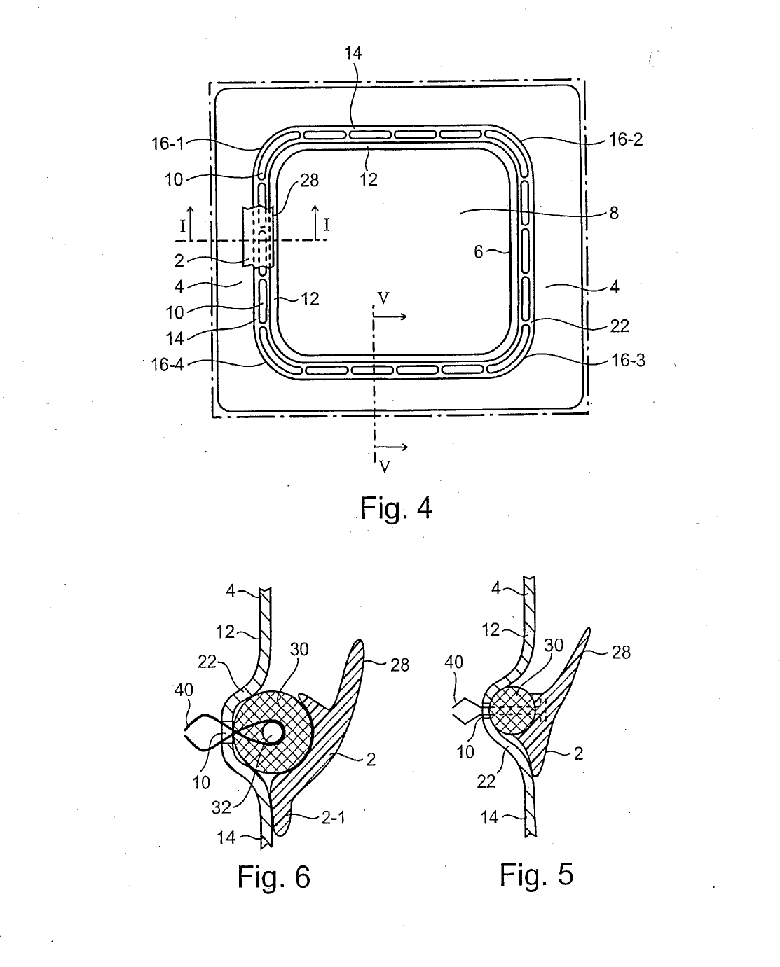

FIG. 1 shows a cross-section along the plane I-I of FIG. 4 of an oven seal according to the present invention,

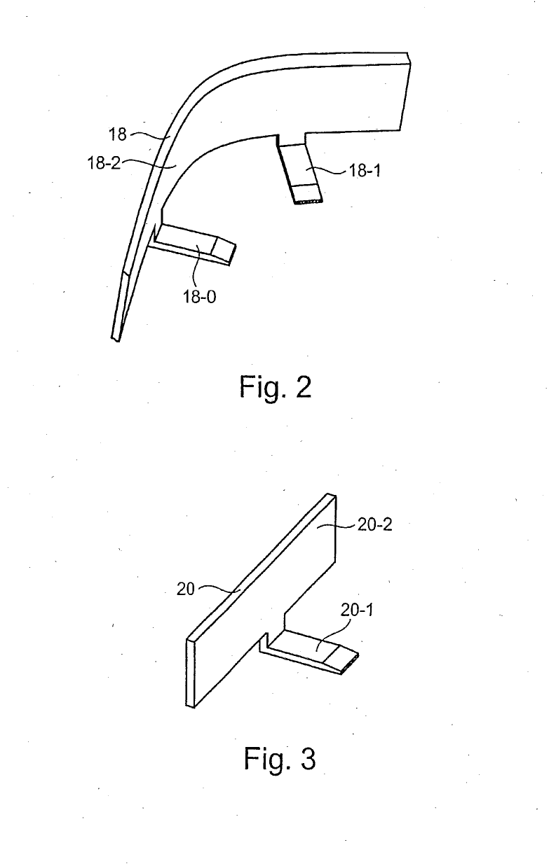

FIG. 2 is a perspective view of a corner hook for attaching a corner section of the sealing element shown in FIG. 1,

FIG. 3 is a perspective view of a central hook for attaching the sealing element illustrated in FIG. 1 on a straight section between corner sections of the sealing element of FIG. 1,

FIG. 4 is a diagrammatic view of a front view of an oven according to the present invention,

FIGS. 5 to 9 show various embodiments of an oven seal according to the present invention, as viewed along the plane V-V of FIG. 4,

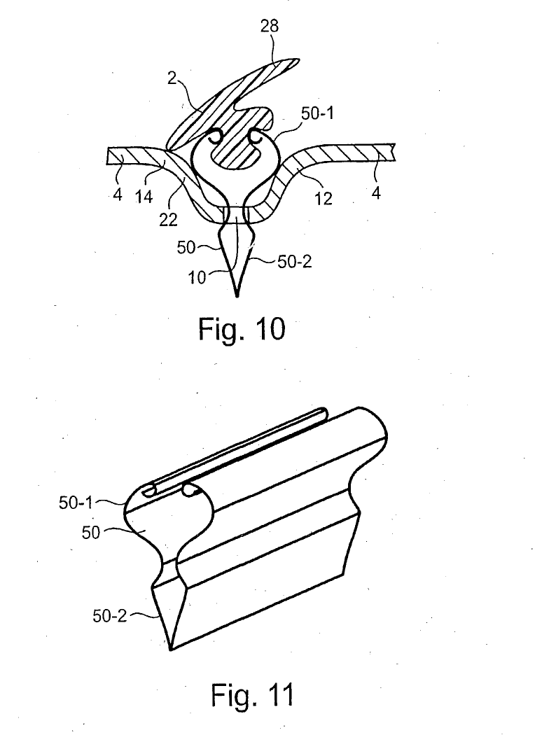

FIG. 10 shows another embodiment of an oven seal according to the present invention, as viewed along the plane I-I of FIG. 4,

FIG. 11 is a perspective view of a fastening element for attaching the sealing element shown in FIG. 10 on an oven side or an oven flange,

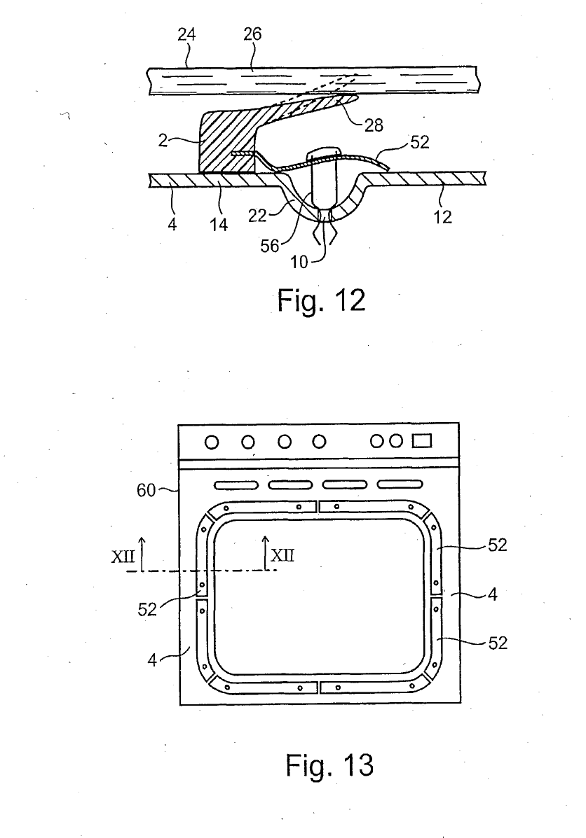

FIG. 12 is a diagrammatic view of another embodiment of an oven seal according to the present invention, as viewed in the plane XII-XII of FIG. 13,

FIG. 13 diagrammatically shows a front view of an oven according to the present invention, which is illustrated diagrammatically without an oven door.

The oven seal according to the present invention shown disassembled in cross-section in FIG. 1 has a sealing element 2, extending on an oven front side, hereinbelow referred to as oven flange 4, in the manner of a frame around the supply opening 6 of an oven space 8 and a thermal decoupling area 10. The thermal decoupling area 10 separates heat-wise a “hot area” 12 (hot side) adjacent to the supply opening 6 from a “cold area” 14 (cold side) further removed from the supply opening 6 relative thereto. The thermal decoupling area 10 preferably extends around the entire supply opening 6 and can be formed by an uninterrupted gap in the oven flange 4, by at least a groove or bead or, corresponding to FIGS. 1 and 4, by a successive plurality of slots or openings 10 around the supply opening 6.

The sealing element 2 is arranged to rest only on the cool area 14 of the oven flange 4, without it coming into contact with the hot area 12.

The sealing element 2 is attached at the round flange corners 16-1, 16-2, 16-3, 16-4) by corner hooks 18 and on the straight sections of the oven flange 4 by central hooks 20, each of which has at least one end 18-0, 18-1 or 20-1 hooked in through the slot 10 of the thermal decoupling area and one end 18-2 or 20-2 attached to the sealing element 2, preferably integrated into the sealing element 2, for example during production of the sealing element in the injection moulding process or an extrusion process or by vulcanising.

The sealing element 2 comprises an easy-to-clean, optically acceptable material substantially insensitive to oven soiling, silicon for example, which has temperature resistance up to around 280° C.

The fastening elements 18 and 20 preferably comprise metal and are substantially more heat-resistant than the sealing element 2.

The openings 10 forming the thermal decoupling area can be formed in a surface area or in a groove or bead 22, which is embossed in the direction from an oven door 24 to the oven flange 41 and also acts as heat separation means. From the oven door 24 only one glass pane 26 of a viewing window of the oven door 24 is shown, which rests on a wing-like sealing lug 28 of the sealing element 2 when closed and in the process elastically bends this sealing element 28 from a position 28-1 illustrated in dashed lines into the position illustrated in unbroken lines. The sealing lug 28 extends approximately over the entire width of the bead 22 from the cool area 14 at a distance over the openings 10 of the thermal decoupling area to over the hot area 12 and is at a distance from this hot area 12.

The sealing element 2 has a sealing section 2-1 resting on the cool area 14 and an intermediate sealing section 2-2 extending therefrom in the direction from the cool area 14 over the openings 10 over to the hot area 12, and which is situated between the hot area 12 and the sealing lug 28 and is supported by a low heat-conducting support 30 on the hot area 12 and is at the same time kept at a distance from the hot area 12. The support 30 may comprise metal, though preferably likewise comprises a sealing material, which however has a substantially higher temperature resistance than the sealing element 2, whereby the temperature resistance is so high, above 350 OC for example, that it is not damaged by the hot temperatures of the hot area 12 when in pyrolysis mode. The support 30 is preferably a fibre glass fabric strand which extends parallel to the sealing element 2 and is preferably attached thereto, for example by adhesion or by vulcanising or by simultaneous production together with the sealing element 2, for example in the injection moulding process or in the extrusion process. The intermediate sealing section 2-2 covers not only the openings 10, but preferably the entire bead 22.

In FIGS. 5 to 13 corresponding parts are designated by identical reference numerals, as in FIGS. 1 to 4.

In FIG. 5 the sealing element 2 lies on a support 30, which comprises sealing material and lies on the base of the bead 22. A fastening element 40 extends through the support 30 to the sealing element 2. The sealing element 2 and the support 30 can be connected inseparably to one another by vulcanising or common production in the extrusion process or the like.

In FIG. 6 the sealing element 2 is attached to a support 30, as per in FIG. 5. The support 30 is a sealing element, for example a fibre glass fabric strand, which lies in the bead 22 and contains a core wire 32, around which plug-in clamps 40 are looped, whose end sections remote from the core wire 32 can be pushed through the openings 10, which form the thermal decoupling area, and spread out elastically from one another behind the latter and thus form fastening elements for the sealing element 2.

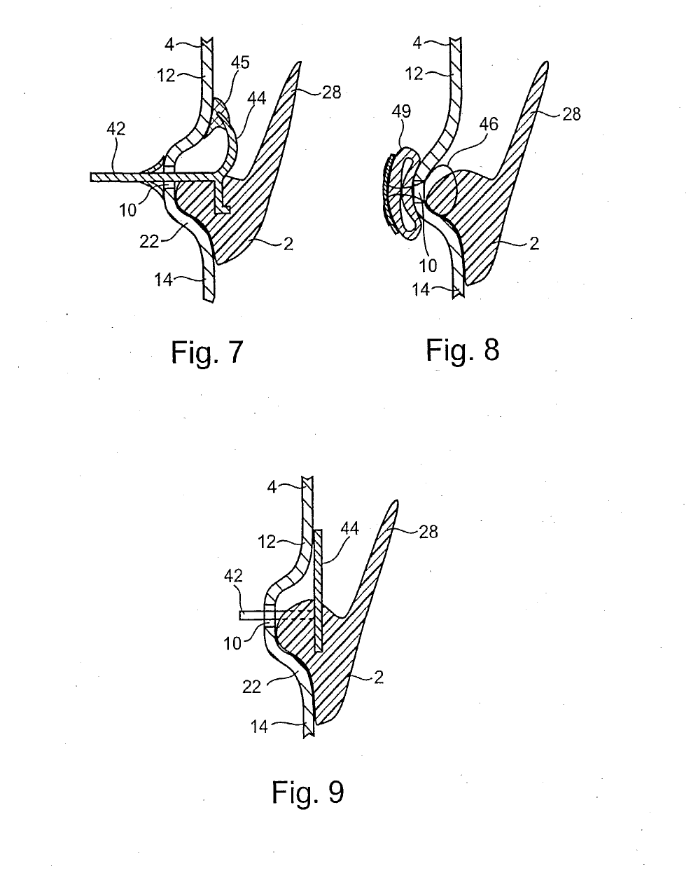

FIG. 7 shows a fastening element 2 with a sealing lug 28 and a straddling dowel 42 suspended in the sealing element 2 as fastening element. The fastening element 42 has a support lug 44 supported via sealing material 45 on the hot area 12.

The sealing element 2 of FIG. 8 is held by a shackle-like fastening element 46 resting on the cool area 14 and at the same time kept at a distance from the hot area 12. As FIG. 8 shows, an additional sealing element 49, comprising sealing material more resistant to heat than one sealing element 2, can be disposed on the rear of the oven flange 4.

FIG. 9 is similar to FIG. 7. The support 44 lies directly on the hot area 12.

In the embodiment in FIG. 10 the sealing element 2 is attached by a plurality of fastening elements 50 on the oven flange 4, which have end 50-1 stuck on the sealing element 2 and an end 50-2 pushed through the openings 10 and spread elastically behind the latter. The fastening elements 50 hold the sealing element 2 in bearing on the cool area 14 and at a distance from the hot area 12 of the oven flange 4. FIG. 11 shows such a fastening element 50 in a perspective view.

In the embodiment in FIGS. 12 and 13 the bead 22 is covered by a plurality of successive heat-resistant covering elements 52, preferably made of metal, e.g. stainless steel, to avoid soiling of the bead 22 by foodstuffs and to improve the optical appearance. The covering elements 52 can be used simultaneously as fastening elements for the sealing element 2 and for this purpose for example have an arm projecting in through the openings 10, or according to FIG. 12 through additional fastening elements 56, which jut through the openings 10, can be attached to the oven flange 4, so that the sealing element 2 is connected via the covering element 52 to the fastening elements 56 and kept in place thereby on the oven flange 4. FIG. 13 diagrammatically illustrates the front side of an oven 60 without the sealing element 2 and without the oven door.

“Sealing element” or “seal” here means respectively a sealing material, which is resilient and isolates the oven space 8 from the atmosphere both thermally and also with respect to oven space steam.

1. An oven containing an oven flange (4), which extends like a frame around the supply opening (6) of an oven space (8) and has a thermal decoupling area (10), which heat-wise separates a “hot area” (12) adjacent to the supply opening (6) and a “cold area” (14) further away from the supply opening relative thereto, and also a sealing element (2) affixed to the oven flange (4) and lying against the latter as a seal, characterised in that the sealing element (2) is arranged resting on the cool area (14) of the oven flange (4), without it contacting the hot area (12).

2. The oven as claimed in claim 1, characterised in that the sealing element (2) at least partially covers fastening means (20; 40; 42; 46; 50; 52; 56), by which it is attached on the oven flange (4).

3. The oven as claimed in claim 2, characterised in that in cross-section the sealing element (2) has a sealing wing (28) extending from the cool area towards the hot area, at a distance over a part of the latter, which at least partially covers the fastening means and which is the sealing element to be contacted by the oven door.

4. The oven as claimed in any one of the preceding claims, characterised in that a support (30; 44; 45;
46; 50-1; 52) is provided, comprising a material more heat-resistant than the sealing element (2) and which supports the sealing element, in addition to its bearing on the cool area (14), on the oven flange (4) at a nearer point in the hot area (12) and/or on the hot area and keeps it at a distance there.

5. The oven as claimed in claim 4, characterised in that the support is a second sealing element (30), comprising a material more heat-resistant than one sealing element (2), preferably a fibre glass sealing material.

6. The oven as claimed in claim 5, characterised in that both the sealing elements (2, 30) are produced together in the extrusion process or injection moulding process and together form a sealing unit.

7. The oven as claimed in claim 4, characterised in that the support (44) comprise at least one fastening element (42; 46; 50; 52), by which the sealing element (2) is attached on the oven flange (4).

8. The oven as claimed in any one of the preceding claims, characterised in that fastening means (20; 40; 42; 46; 52) and/or support means (44; 46; 52) are integrated in the sealing element (2), in particular extruded, injection-moulded or vulcanised, by which the sealing element (2) is attached on the oven flange (4) and/or is kept at a distance from the hot area (12).

9. The oven as claimed in any one of the preceding claims, characterised in that the thermal decoupling area (10) is covered by a metal covering (52), preferably made of stainless steel.

10. The oven as claimed in claim 9, characterised in that the metal covering (52) is formed by fastening means for attaching the sealing element (2) on the oven flange (4).
